(19) United States
(12) Patent Application Publication
(10) Pub. No.: US 2019/0090124 A1
(43) Pub. Date: Mar. 21, 2019

(54) METHOD AND APPARATUS FOR REALIZING A PLURALITY OF TERMINALS SHARING USER IDENTITY IDENTIFICATION CARD, AND STORAGE MEDIUM

(71) Applicant: ZTE CORPORATION, Shenzhen (CN)

(72) Inventor: Haicheng YANG, Shenzhen (CN)

(21) Appl. No.: 16/083,561

(22) PCT Filed: May 16, 2016
(86) PCT No.: PCT/CN2016/082184

§ 371 Date: Sep. 10, 2018

(30) Foreign Application Priority Data
Mar. 10, 2016 (CN) 201610137592.0

(51) Int. Cl. H04W 8/20; H04W 8/24; H04L 29/06; H04W 60/00; H04W 12/06

(52) U.S. Cl. CPC H04W 8/20; H04W 8/24; H04W 12/06; H04W 60/00; H04L 63/0853

(57) ABSTRACT

Disclosed are a method and apparatus for realizing a plurality of terminals sharing a user identity identification card, and a storage medium. The method comprises: a master device applying to a cloud server for taking a number of a user identity identification card of a local machine as a share number to share with a slave device, and sending identity information about the slave device to the cloud server; and the slave device downloading information about the share number from the cloud server, writing the information about the share number into the user identity identification card of the local machine, re-accessing a network by means of the user identity identification card, and using the share number to perform a communication service such as a PS service and a CS service.

### TECHNICAL FIELD

The disclosure relates to the technical field of communications, and in particular to a method and apparatus for realizing sharing of a Subscriber Identity Module (SIM) card among multiple terminals, and a storage medium.

### BACKGROUND

With the development of society and the gradual maturity of technology, mobile terminals have transformed gradually from high-end consumer goods to daily necessities, and have gone deep into daily life of ordinary consumers. At present, a mobile phone, a tablet PC, a smartwatch, a smart bracelet, an intelligent projector and other mobile terminals have been quite popularized, and a family usually has multiple mobile terminals. Each mobile terminal is installed with an SIM card. Different SIM cards have different plans. The plans of some terminals are insufficient, while the plans of other terminals have a surplus, which causes a waste. Moreover, when the SIM cards have overdue bills, a user needs to charge each of the SIM cards. Consequently, it is very inconvenient for the user to manage the SIM cards of multiple terminals, which seriously impacts the user experience.

### SUMMARY

Embodiments of the disclosure provide a method and apparatus for realizing sharing of an SIM card among multiple terminals, and a storage medium, aiming at solving the problem that it is inconvenient for a user to manage the SIM cards of multiple terminals.

The embodiments of the disclosure provide a method for realizing sharing of an SIM card among multiple terminals. The method includes the following steps.

A primary device applies to a cloud server for taking a number of the SIM card of the primary device (namely the primary device) as a shared number to share with a secondary device, and sends identity information about the secondary device to the cloud server.

The secondary device downloads information about the shared number from the cloud server, writes the information about the shared number into the SIM card of the primary device (namely the secondary device), re-accesses a network by means of the SIM card, and perform a communication service, such as a Packet Switch (PS) service and a Circuit Switch (CS) service, by using the shared number.

In the embodiments of the disclosure, the method further includes that:

the primary device queries the cloud server for usage information about the shared number on the secondary device, or/and manages a sharing state of the shared number on the secondary device through the cloud server.

The embodiments of the disclosure also provide a method for realizing sharing of an SIM card among multiple terminals, which is applied to the primary device. The method includes the following steps.

An application for taking the number of the SIM card of the primary device (namely the primary device) as the shared number to share with the secondary device is sent to the cloud server.

The identity information about the secondary device is sent to the cloud server.

The shared number is written into the SIM card of the secondary device, so that the secondary device uses the shared number to perform the communication services when re-accessing a network by means of the SIM card of the secondary device.

In the embodiments of the disclosure, the method further includes that:

the cloud server is queried for the usage information about the shared number on the secondary device, or/and the sharing state of the shared number on the secondary device is managed through the cloud server.

In the embodiments of the disclosure, that the sharing state of the shared number on the secondary device is managed includes that: the sharing of the shared number on the secondary device is paused, resumed or cancelled.

The embodiments of the disclosure also provide a method for realizing sharing of an SIM card among multiple terminals, which is applied to the secondary device. The method includes the following steps.

The information about the shared number is downloaded from the cloud server. The shared number is the number of the SIM card of the primary device.

The information about the shared number is written into the SIM card of the local device (namely the secondary device).

A network is re-accessed through the SIM card, and the shared number is used to perform the communication services, such as the PS service and the CS service.

The embodiments of the disclosure also provide an apparatus for realizing sharing of an SIM card among multiple terminals, which is applied to the primary device. The apparatus includes an applying module. The applying module is configured to apply to the cloud server for taking the number of the SIM card of the local device (namely the primary device) as the shared number to share with the secondary device, and send the identity information about the secondary device to the cloud server.

The shared number is written into the SIM card of the secondary device, so that the secondary device uses the shared number to perform the communication services when re-accessing a network by means of the SIM card of the secondary device.

In the embodiments of the disclosure, the apparatus further includes a sharing managing module. The sharing managing module is configured to query the cloud server for the usage information about the shared number on the secondary device, or/and manage the sharing state of the shared number on the secondary device.

In the embodiments of the disclosure, the sharing managing module is configured to pause, resume or cancel, through the cloud server, the sharing of the shared number on the secondary device.

The embodiments of the disclosure also provide an apparatus for realizing sharing of an SIM card among multiple terminals, which is applied to the secondary device. The apparatus includes a downloading module, a writing module, and a service managing module.

The downloading module is configured to download information about a shared number from a cloud server, wherein the shared number is the number of an SIM card of a primary device;

The writing module is configured to write the information about the shared number into the SIM card of the primary device (namely the secondary device).

The service managing module is configured to, after the information about the shared number is written into the SIM card of the primary device, re-access a network through the SIM card, and perform the communication services, such as the PS service and the CS service, by using the shared number.

The embodiments of the disclosure also provide a storage medium, in which a computer program is stored. The computer program is configured to perform the method for realizing sharing of an SIM card among multiple terminals.

Through the method for realizing sharing of an SIM card among multiple terminals provided by the disclosure, by sharing the number of the SIM card of the primary device with the secondary device, the secondary device may download the information about the number and write the information into the reprogrammable SIM card of the secondary device, so that the secondary device may also use the number to perform the communication services, such as the PS service and the CS service. Therefore, sharing of a data traffic plan or/and a call plan of an SIM card among multiple terminals is realized. In such a manner, a user may merely charge a single SIM card to satisfy the use of the multiple terminals, thereby not only facilitating a user in performing unified and efficient management on an SIM card, but also making full use of a plan of the SIM card, and improving the user experience.

### BRIEF DESCRIPTION OF DRAWINGS

FIG. 1 is a flowchart of a method for realizing sharing of an SIM card among multiple terminals according to the first embodiment of the disclosure.

FIG. 2 is a specific flowchart showing that a primary device applies for sharing a number of an SIM card according to an embodiment of the disclosure.

FIG. 3 is a specific flowchart showing that a secondary device downloads information about a shared number according to an embodiment of the disclosure.

FIG. 4 is a specific flowchart showing that the secondary device writes the information about the shared number into the SIM card of the primary device according to an embodiment of the disclosure.

FIG. 5 is a flowchart of a method for realizing sharing of an SIM card among multiple terminals according to the second embodiment of the disclosure.

FIG. 6 is a specific flowchart showing that the primary device queries for usage information about the shared number on the secondary device according to an embodiment of the disclosure.

FIG. 7 is a schematic diagram showing that a cloud server returns the usage information about the shared number to the primary device.

FIG. 8 is a specific flowchart showing that the primary device pauses the sharing of the shared number on the secondary according to an embodiment of the disclosure.

FIG. 9 is a specific flowchart showing that the primary device resumes the sharing of the shared number on the secondary according to an embodiment of the disclosure.

FIG. 10 is a specific flowchart showing that the primary device cancels the sharing of the shared number on the secondary according to an embodiment of the disclosure.

FIG. 11 is a flowchart of a method for realizing sharing of an SIM card among multiple terminals, which is applied to the primary device, according to the third embodiment of the disclosure.

FIG. 12 is a flowchart of a method for realizing sharing of an SIM card among multiple terminals, which is applied to the primary device, according to the fourth embodiment of the disclosure.

FIG. 13 is a flowchart of a method for realizing sharing of an SIM card among multiple terminals, which is applied to the secondary device, according to the fifth embodiment of the disclosure.

FIG. 14 is a module diagram of a system for realizing sharing of an SIM card among multiple terminals according to the sixth embodiment of the disclosure.

FIG. 15 is a module diagram of an apparatus for realizing sharing of an SIM card among multiple terminals, which is applied to the primary device, according to the seventh embodiment of the disclosure.

FIG. 16 is a module diagram of an apparatus for realizing sharing of an SIM card among multiple terminals, which is applied to the secondary device, according to the eighth embodiment of the disclosure.

FIG. 17 is a module diagram of an apparatus for realizing sharing of an SIM card among multiple terminals according to the ninth embodiment of the disclosure.

The achievement of purpose, functional characteristics and advantages of the disclosure are further elaborated in combination with the embodiments and with reference to the accompanying drawings.

### DETAILED DESCRIPTION

It should be understood that the specific embodiments described here are only used for illustrating the disclosure and not intended to limit the disclosure.

### Embodiment One

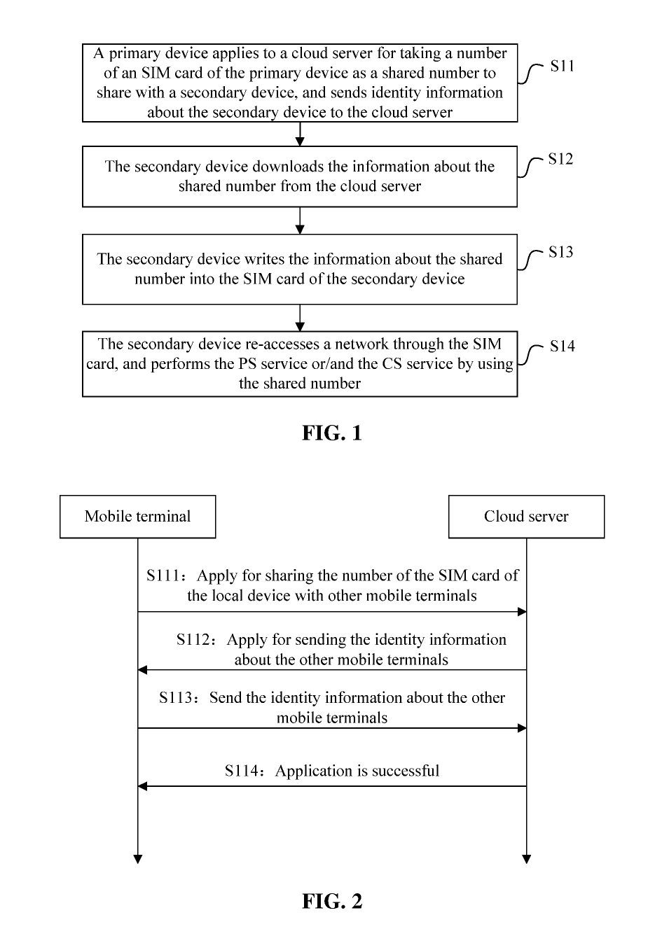

With reference to FIG. 1, a method for realizing sharing of an SIM card among multiple terminals according the first embodiment of the disclosure is provided. The method includes the following steps.

At S11, a primary device applies to a cloud server for taking a number of an SIM card of the primary device as a shared number to share with a secondary device, and sends identity information about the secondary device to the cloud server.

Both the primary device and the secondary device in the disclosure are terminal devices, preferably a mobile phone, a tablet PC, a smartwatch, a smart bracelet, an intelligent projector and other mobile terminals. The cloud server may be either a server of the operator, or a server from a third party which has bought a number segment of the operator. The identity information about the secondary device may be SIM card information or/and device identification information of the secondary device, and is used for authenticating when the secondary device downloads information about the shared number. The identity information may also serve as an encrypting parameter of the information about the shared number.

In the disclosure, when the terminal device shares a number as the primary device, it may share one communication service or at least two communication services of the number. For example, the terminal device may only share a PS service of the number, that is, the terminal device only shares a data service of the number, and shares the Internet data traffic of the number with a terminal device serving as a secondary device, which is applied to a situation where the primary device has more Internet data traffic; the terminal device may also only share a CS service of the number, that is, the terminal device only shares a voice service, a short messaging service and other services of the number, which is applied to a situation where the primary device has a big call plan and a big short message plan; the terminal device may also share both the PS service and the CS service of the number.

Now, taking a mobile terminal as an example, a specific flow in which the mobile terminal applies for sharing the number of the SIM card may be as shown in FIG. 2. The flow includes the following steps.

At S111, the mobile terminal applies to the cloud server for sharing the number of the SIM card of the primary device with other mobile terminals.

In S111, when sending application information, the mobile terminal may make it clear that which communication service is to be shared, for example, the PS service or the CS service, or both of them. At this point, the mobile terminal sending the application is the primary device, and the other mobile terminals accepting the sharing are the secondary devices. There may be at least one secondary device, or there may be multiple secondary devices.

At S112, the cloud server applies for sending the identity information about the other mobile terminals.

At S113, the mobile terminal sends the identity information about the other mobile terminals to the cloud server.

The identity information may be the SIM card information or/and the device identification information. The mobile terminal sends the SIM card information or/and the device identification information of each secondary device to the cloud server.

At S114, the cloud server returns information “application is successful” to the mobile terminal.

Specifically, the cloud server stores the application information of the primary device and the identity information about the secondary devices, and returns the information “application is successful” to the primary device. At this time, the primary device's application for sharing the number succeeds.

At S12, the secondary device downloads the information about the shared number from the cloud server.

After the primary device completes the application for sharing the number, the secondary device may download the information about the shared number from the cloud server. The secondary device may actively apply to the cloud server for downloading the information about the shared number, or download the information about the shared number according to a prompt of the cloud server.

Now, taking that the secondary device is the mobile terminal as an example, a specific flow in which the secondary device downloads the information about the shared number may be as shown in FIG. 3. The flow includes the following steps.

At S121, the cloud server sends sharing prompt information to the mobile terminal to query whether to perform downloading.

For example, the cloud server sends to each secondary device the sharing prompt information “someone shares his/her data traffic with you, download his/her number information?”. Of course, the sharing prompt information may include other contents or may be in other forms, which will not be illustrated one by one.

At S122, the mobile terminal sends information “confirm to perform downloading” to the cloud server.

At S123, the cloud server initiates an authentication request to the mobile terminal.

At S124, the mobile terminal sends the identity information about the primary device to the cloud server.

The identity information may be the SIM card information or/and the device identification information of the primary device.

At S125, the cloud server verifies the identity information sent by the mobile terminal, and after confirming that the identity is valid, encrypts the information about the shared number and sends the encrypted shared number to the mobile terminal.

At S126, the mobile terminal sends information “downloading is completed” to the cloud server.

The mobile terminal downloads the information about the shared number locally, saves the information after the download is completed, and sends feedback information to the cloud server.

At S13, the secondary device writes the information about the shared number into the SIM card of the secondary device.

Specifically, after acquiring the information about the shared number, the secondary device writes the information about the shared number into the reprogrammable SIM card of the secondary device.

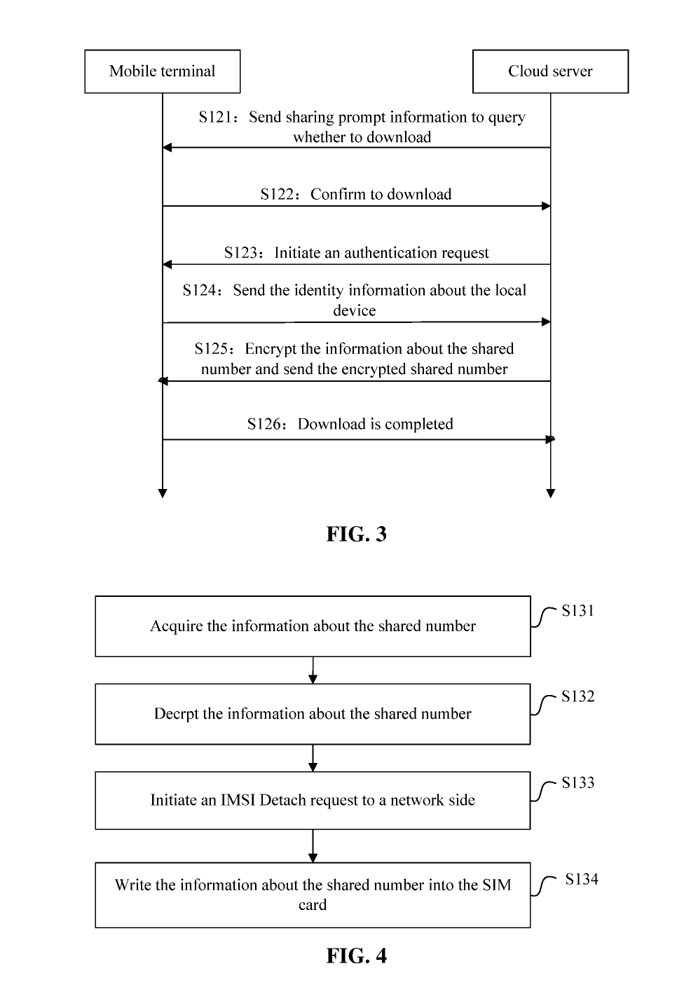

Now, taking that the secondary device is the mobile terminal as an example, a specific flow in which the secondary device writes the information about the shared number into the SIM card of the secondary device may be as shown in FIG. 4. The flow includes the following steps.

At S131, the information about the shared number is acquired.

The information about the shared number which is downloaded from the cloud server and saved locally is acquired.

At S132, the information about the shared number is decrypted.

If the information about the shared number has been encrypted by the cloud server, the information about the shared number needs to be decrypted.

At S133, an IMSI Detach request is initiated to a network side.

The IMSI is the short form for International Mobile Subscriber Identification Number, and Detach is detaching the terminal from the network.

At S134, the information about the shared number is written into the SIM card.

The information about the shared number includes an Integrate Circuit Card Identity (ICCID), an IMSI, a Key Identifier (KI), a key, an Operator Variant Algorithm Configuration Field (OP), a Forbidden Public Land Mobile Network (FPLMN), a Home Public Land Mobile Network (HPLMN), and other parameter information.

At S14, the secondary device re-accesses a network through the SIM card, and uses the shared number to perform the PS service or/and the CS service.

Specifically, after writing the information about the shared number into the SIM card of the secondary device, the secondary device restarts the SIM card, searches a network again through the SIM card and accesses the network, and uses the shared number to perform the PS service or/and the CS service, or other communication services.

In some embodiments, when performing the PS service (e.g. the data service), the secondary device preferentially uses the shared number to initiate an Attach request of the PS service, if failed, the secondary device turns to use the number of the secondary device to perform the attach operation. When performing the CS service (e.g. the call service and the short message service), the secondary device always uses the number of the secondary device to perform the attach operation.

In some other embodiments, when performing the CS service, the secondary device preferentially uses the shared number to initiate an Attach request of the CS service, if failed, the secondary device turns to use the number of the secondary device to perform the attach operation. When performing the PS service, the secondary device always uses the number of the secondary device to perform the attach operation.

In some other embodiments, whether performing the PS service or the CS service, the secondary device preferentially uses the shared number to initiate the Attach request, if failed, the secondary device turns to use the number of the secondary device to attach.

By using the method for realizing sharing of an SIM card among multiple terminals, the user may share the number of the SIM card of the primary device with other secondary devices, so that the multiple terminals may share the data traffic plan or/and the call plan of an SIM card. In such a manner, the user may merely charge a single SIM card to satisfy the use of the multiple terminals, thereby not only facilitating the user in performing unified and efficient management on the SIM card, but also making full use of the plan of the SIM card, and improving the user experience.

### Embodiment Two

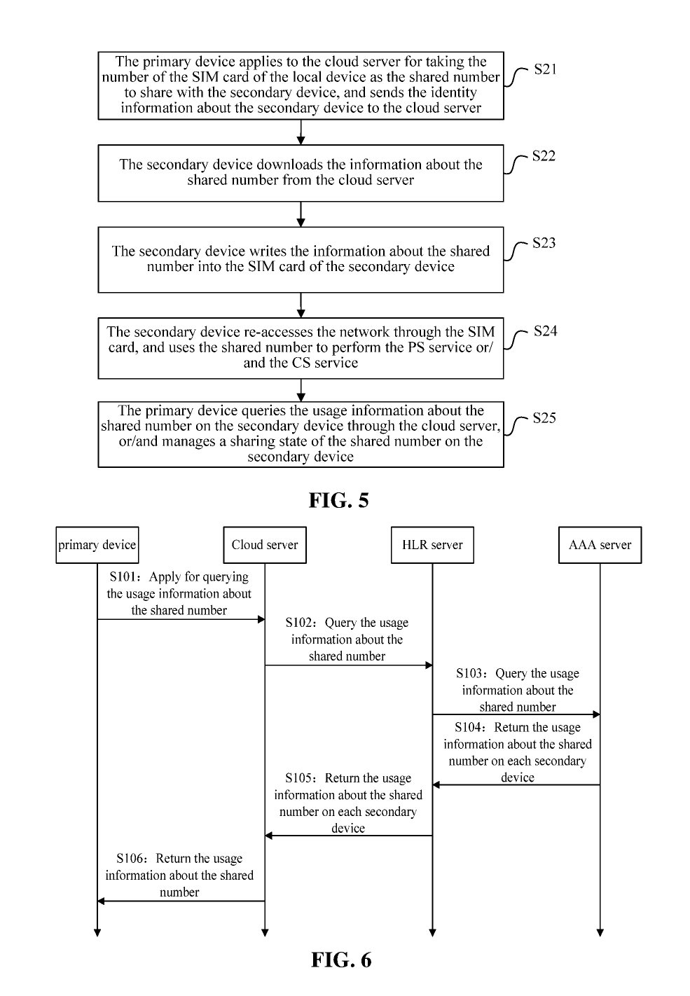

With reference to FIG. 5, a method for realizing sharing of an SIM card among multiple terminals according the second embodiment of the disclosure is provided. The method includes the following steps.

At S21, the primary device applies to the cloud server for taking the number of the SIM card of the primary device as the shared number to share with the secondary device, and sends the identity information about the secondary device to the cloud server.

At S22, the secondary device downloads the information about the shared number from the cloud server.

At S23, the secondary device writes the information about the shared number into the SIM card of the secondary device.

At S24, the secondary device re-accesses the network through the SIM card, and uses the shared number to perform the PS service or/and the CS service.

The steps from S21 to S24 in the present embodiment are as same as the steps from S11 to S14 in the first embodiment, so they will not be repeated here.

At S25, the primary device queries the usage information about the shared number on the secondary device through the cloud server, or/and manages a sharing state of the shared number on the secondary device.

In the present embodiment, the primary device may also manage the sharing of the shared number, including checking the use (e.g. data traffic usage, call duration, and the number of short messages sent) of the shared number on the secondary device, pausing, resuming or cancelling the sharing of the shared number on the secondary device. A detailed description is given below.

A specific flow in which the primary device queries the usage information about the shared number on the secondary device may be as shown in FIG. 6. The flow includes the following steps.

At S101, the primary device initiates an application to the cloud server for querying the usage information about the shared number.

The usage information may be the data traffic usage, or may be the call duration and the number of short messages sent, or may be both of them.

At S102, the cloud server initiates a query to an HLR server which is in charge of the shared number.

The HLR is the short form for Home Location Register.

At S103, the HLR server initiates a query to an AAA server.

The AAA is the short form for Authentication, Authorization, and Accounting.

At S104, the AAA server returns the usage information about the shared number on each secondary device to the HLR server.

At S105, the HLR server returns the usage information about the shared number on each secondary device to the cloud server.

At S106, the cloud server returns the usage information about the shared number to the primary device.

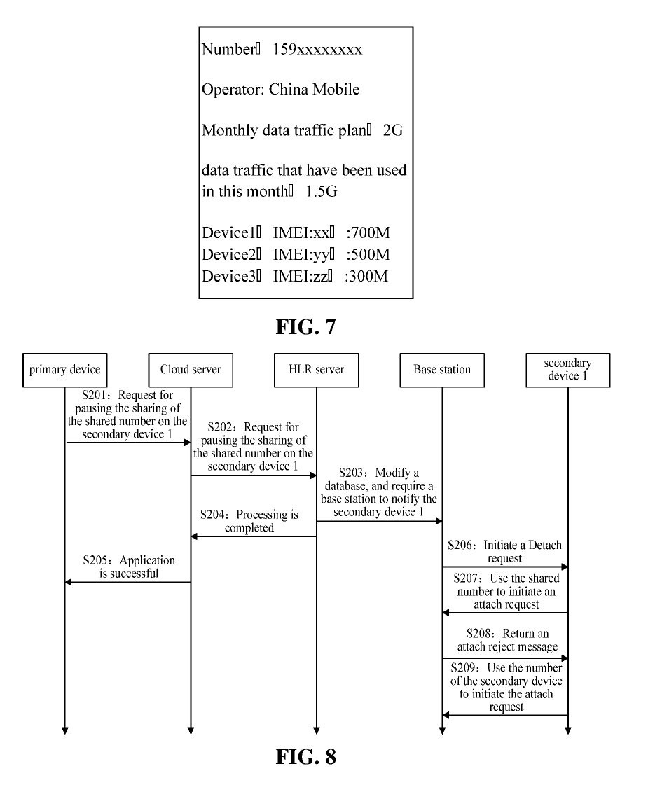

The usage information returned by the cloud server at least includes the usage information about the shared number on each secondary device, and may further include the following information of the shared number: the total amount of the monthly plan, the amount of the plan which has been used in this month, and the remaining amount of the plan. Taking sharing the Internet data traffic (namely the PS service) as an example, as shown in FIG. 7, information about the usage of data traffic of the shared number returned by the cloud server includes the total amount of the monthly data traffic plan, the amount of the data traffic plan which has been used in this month, and details about the usage of data traffic on each secondary device.

A specific flow in which the primary device pauses the sharing of the shared number on the secondary device may be as shown in FIG. 8. The flow includes the following steps.

At S201, the primary device initiates an application to the cloud server for pausing the sharing of the shared number on the secondary device 1, for example, pausing the sharing of data traffic.

Alternatively, the primary device may also apply for pausing the sharing of the shared number on multiple secondary devices once.

At S202, the cloud server initiates a service request to the HLR server which is in charge of the shared number is to request for pausing the sharing of the shared number on the secondary device 1.

At S203, the HLR server modifies a database, and requires a base station to notify the secondary device 1.

At S204, the HLR server notifies the cloud server that the processing is completed.

At S205, the cloud server returns the information “application is successful” to the primary device.

After the application for pausing the sharing is successful, the flow further includes the following steps.

At S206, the base station initiates the Detach request to the device 1. The type of the Detach is “re-attach required”.

At S207, the secondary device 1 uses the shared number to initiate the Attach request to the base station, for attempting to reactivate the PS service or/and the CS service.

At S208, the base station returns an Attach Reject message.

At S209, the secondary device 1 uses the number of the secondary device to initiate the Attach request to the base station, and activates the PS service or/and the CS service successfully.

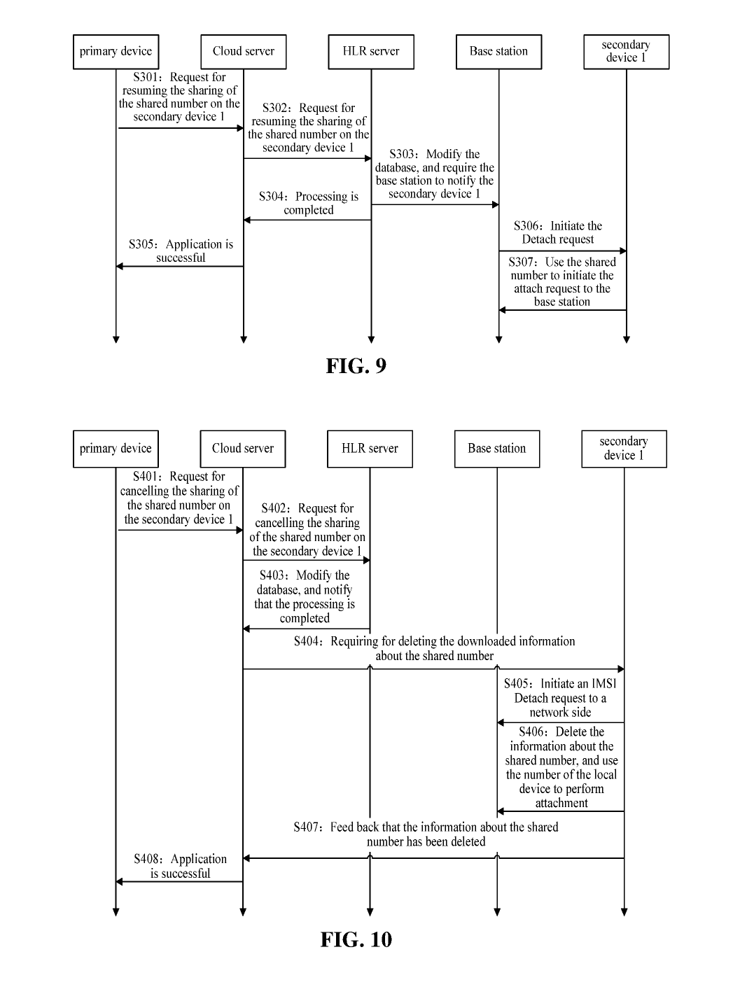

A specific flow in which the primary device resumes the sharing of the shared number on the secondary device may be as shown in FIG. 9. The flow includes the following steps.

At S301, the primary device initiates an application to the cloud server for resuming the sharing of the shared number on the secondary device 1, for example, resuming the sharing of data traffic.

At S302, the cloud server initiates the service request to the HLR server which is in charge of the shared number is to request for resuming the sharing of the shared number on the secondary device 1.

At S303, the HLR server modifies the database, and requires the base station to notify the secondary device 1.

At S304, the HLR server notifies the cloud server that the processing is completed.

At S305, the cloud server returns the information “application is successful” to the primary device.

After the application for resuming the sharing is successful, the flow further includes the following steps.

At S306, the base station initiates the Detach request to the device 1. The type of the Detach is “re-attach required”.

At S307, the secondary device 1 uses the shared number to initiate the Attach request to the base station, for reactivating the PS service or/and the CS service.

A specific flow in which the primary device cancels the sharing of the shared number on the secondary device may be as shown in FIG. 10. The flow includes the following steps.

At S401, the primary device initiates an application to the cloud server for cancelling the sharing of the shared number on the secondary device, for example, cancelling the sharing of data traffic.

At S402, the cloud server initiates the service request to the HLR server which is in charge of the shared number to request for canceling the sharing of the shared number on the secondary device.

At S403, the HLR server modifies the database, and notifies the cloud server that the processing is completed.

At S404, the cloud server requires the secondary device 1 to delete the downloaded information about the shared number.

At S405, the secondary device 1 initiates the IMSI Detach request to the network side.

At S406, the secondary device 1 deletes the information about the shared number, and uses the number of the secondary device to perform the attach operation.

At S407, the secondary device 1 feeds back that information about the shared number has been deleted to the cloud server.

At S408, the cloud server returns the information “application is successful” to the primary device.

By using the method for realizing sharing of an SIM card among multiple terminals in the present embodiment, the user is allowed to manage the sharing of the SIM card through the primary device, including not only querying the usage information of the plan of the SIM card on each secondary device, but also pausing, resuming or cancelling the sharing of the SIM card on a certain secondary device. Therefore, it is more convenient for the user to perform unified management on the SIM card.

### Embodiment Three

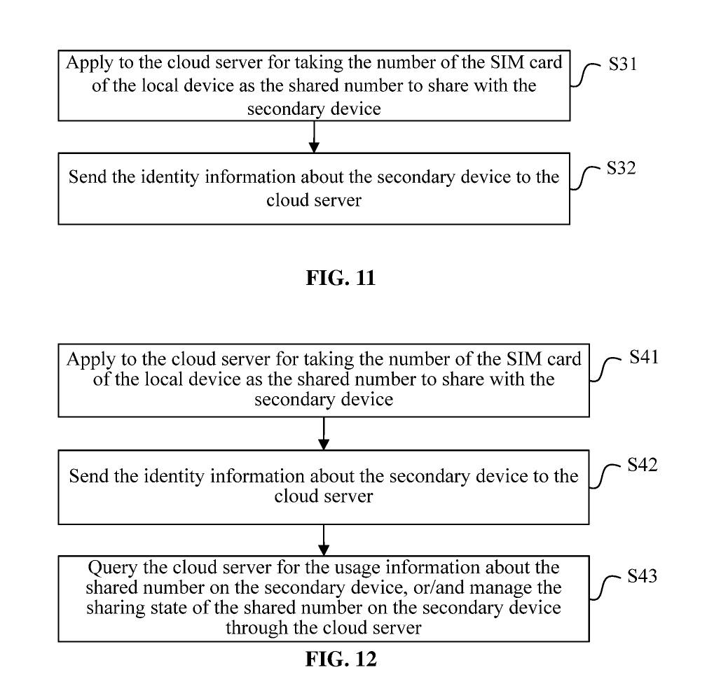

With reference to FIG. 11, a method for realizing sharing of an SIM card among multiple terminals according the third embodiment of the disclosure is provided. The method includes the following steps.

At S31, an application for taking the number of the SIM card of the primary device as the shared number to share with the secondary device is sent to the cloud server.

At S32, the identity information about the secondary device is sent to the cloud server.

S31 and S32 in the present embodiment are as same as S11 in the first embodiment. The specific process that the primary device applies for sharing the number may refer to the description of S11 in the first embodiment, which will not be repeated here.

By using the method for realizing sharing of an SIM card among multiple terminals, the user may share the number of the SIM card of the primary device with other secondary devices, so that the multiple terminals may share the data traffic plan or/and the call plan of the SIM card. In such a manner, the user may merely charge a single SIM card to satisfy the use of the multiple terminals, thereby not only facilitating the user in performing unified and efficient management on the SIM card, but also making full use of the plan of the SIM card, and improving the user experience.

### Embodiment Four

With reference to FIG. 12, a method for realizing sharing of an SIM card among multiple terminals according the fourth embodiment of the disclosure, which is applied to the primary device, is provided. The method includes the following steps.

At S41, the primary device applies to the cloud server for taking the number of the SIM card of the primary device as the shared number to share with the secondary device.

At S42, the primary device sends the identity information about the secondary device to the cloud server.

S41 and S42 in the present embodiment are as same as S11 in the first embodiment. The specific process that the primary device applies for sharing the number may refer to the description of S11 in the first embodiment, which will not be repeated here.

At S43, the primary device queries the usage information about the shared number on the secondary device, or/and manages the sharing state of the shared number on the secondary device through the cloud server. Managing the sharing state includes: pausing, resuming or cancelling the sharing of the shared number on the secondary device.

S43 is as same as S25 in the second embodiment, so it will not be repeated here.

By using the method for realizing sharing of an SIM card among multiple terminals in the present embodiment, the user is also allowed to manage the sharing of the SIM card through the primary device, including not only querying the usage information of the plan of the SIM card on each secondary device, but also pausing, resuming or cancelling the sharing of the SIM card on a certain secondary device. Therefore, it is more convenient for the user to perform unified management on the SIM card.

### Embodiment Five

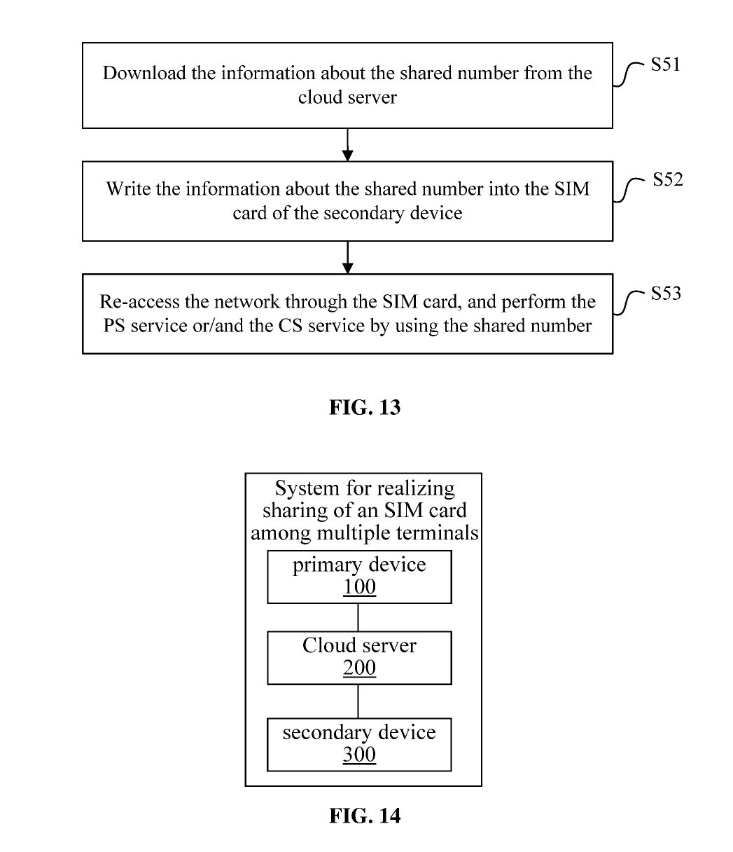

With reference to FIG. 13, a method for realizing sharing of an SIM card among multiple terminals according the fifth embodiment of the disclosure, which is applied to the secondary device, is provided. The method includes the following steps.

At S51, the secondary device downloads the information about the shared number from the cloud server.

At S52, the secondary device writes the information about the shared number into the SIM card of the secondary device.

At S53, the secondary device re-accesses the network through the SIM card, and uses the shared number to perform the PS service or/and the CS service.

The steps from S51 to S53 in the present embodiment are as same as the steps from S12 to S14 in the first embodiment, so they will not be repeated here.

By using the method for realizing sharing of an SIM card among multiple terminals, the user may share the number of the SIM card of the primary device with other secondary devices, so that the multiple terminals may share the data traffic plan or/and the call plan of the SIM card. In such a manner, the user may merely charge a single SIM card to satisfy the use of the multiple terminals, thereby not only facilitating the user in performing unified and efficient management on the SIM card, but also making full use of the plan of the SIM card, and improving the user experience.

### Embodiment Six

With reference to FIG. 14, a system for realizing sharing of an SIM card among multiple terminals according the sixth embodiment of the disclosure is provided. The system includes: a primary device 100, a cloud server 200 and a secondary device 300. Both the primary device 100 and the secondary device 300 are the terminal devices, preferably a mobile phone, a tablet PC, a smartwatch, a smart bracelet, an intelligent projector and other mobile terminals. The cloud server 300 may be either the server of the operator, or a server from a third party which bought a number segment of the operator. A primary device 100 corresponds at least one a secondary device 300, or may correspond to two or more secondary devices 300.

The primary device 100 is configured to apply to the cloud server 200 for taking the number of the SIM card of the primary device as the shared number to share with the secondary device 300, and send the identity information about the secondary device 300 to the cloud server 200. The identity information may be the SIM card information or/and the device identification information of the secondary device 300.

The secondary device 300 is configured to download the information about the shared number from the cloud server 200, write the information about the shared number into the SIM card of the secondary device, re-access the network through the SIM card, and use the shared number to perform the PS service or/and the CS service.

In the present embodiment, the primary device 100 is further configured to query, through the cloud server, the usage information about the shared number on the secondary device 300, or/and manage the sharing state of the shared number on the secondary device. Managing the sharing state includes: pausing, resuming or cancelling the sharing of the shared number on the secondary device.

The system for realizing sharing of an SIM card among multiple terminals allows the user to share the number of the SIM card of the primary device with other secondary devices, so that the multiple terminals may share the data traffic plan or/and the call plan of the SIM card. In such a manner, the user may merely charge a single SIM card to satisfy the use of the multiple terminals, thereby not only facilitating the user in performing unified and efficient management on the SIM card, but also making full use of the plan of the SIM card, and improving the user experience.

It should be understood that the system for realizing sharing of an SIM card among multiple terminals and the method for realizing sharing of an SIM card among multiple terminals provided in the above embodiments belong to the same conception. The specific implementation process of the system may refer to the embodiment of the method, and the technical features in the embodiment of the method are applied correspondingly to the embodiment of the system, so they will not be repeated here.

### Embodiment Seven

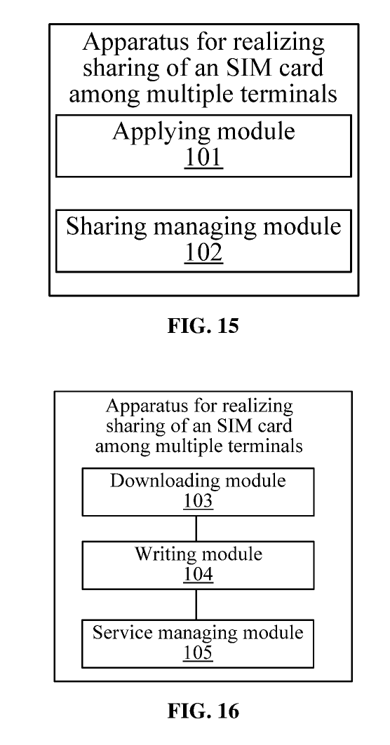

With reference to FIG. 15, an apparatus for realizing sharing of an SIM card among multiple terminals according to the seventh embodiment of the disclosure, which is applied to the primary device, is provided. The apparatus includes an applying module 101. The applying module 101 is configured to apply to the cloud server for taking the number of the SIM card of the primary device as the shared number to share with the secondary device, and send the identity information about the secondary device to the cloud server.

In the present embodiment, the apparatus further includes a sharing managing module 102. The sharing managing module 102 is configured to query the usage information about the shared number on the secondary device through the cloud server, or/and manage the sharing state of the shared number on the secondary device. Managing the sharing state includes: pausing, resuming or cancelling the sharing of the shared number on the secondary device.

### Embodiment Eight

With reference to FIG. 16, an apparatus for realizing sharing of an SIM card among multiple terminals according to the eighth embodiment of the disclosure, which is applied to the secondary device, is provided. The apparatus includes a downloading module 103, a writing module 104 and a service managing module 105.

The downloading module 103 is configured download the information about the shared number from the cloud server.

The writing module 104 is configured to write the downloaded information about the shared number into the SIM card of the secondary device.

The service managing module 105 is configured to, after the information about the shared number is written into the SIM card of the secondary device, re-access the network through the SIM card, and use the shared number to perform the PS service or/and the CS service.

### Embodiment Nine

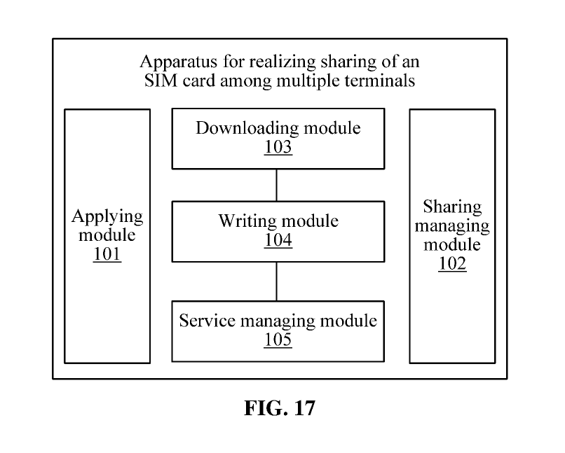

With reference to FIG. 17, an apparatus for realizing sharing of an SIM card among multiple terminals according to the ninth embodiment of the disclosure is provided. The apparatus is applied to the terminal devices, especially a mobile phone and a tablet PC. The apparatus includes the applying module 101, the downloading module 103, the writing module 104 and the service managing module 105.

The applying module 101 is configured to, when the terminal device serves as the primary device, apply to the cloud server for taking the number of the SIM card of the primary device as the shared number to share with the secondary device, and send the identity information about the secondary device to the cloud server.

The downloading module 103 is configured to, when the terminal device serves as the secondary device, download the information about the shared number from the cloud server.

The writing module 104 is configured to write the information about the shared number downloaded by the downloading module 103 into the SIM card of the secondary device.

The service managing module 105 is configured to, after the information about the shared number is written into the SIM card of the secondary device, re-access the network through the SIM card, and use the shared number to perform the PS service or/and the CS service.

In the present embodiment, the apparatus further includes a sharing managing module 102. The sharing managing module 102 is configured to, when the terminal device serves as the primary device, query the usage information about the shared number on the secondary device through the cloud server, or/and manage the sharing state of the shared number on the secondary device. Managing the sharing state includes: pausing, resuming or cancelling the sharing of the shared number on the secondary device.

The apparatus for realizing sharing of an SIM card among multiple terminals in the above embodiment allows the user to share the number of the SIM card of the primary device with other secondary devices, so that the multiple terminals may share the data traffic plan or/and the call plan of the SIM card. In such a manner, the user may merely charge a single SIM card to satisfy the use of the multiple terminals, thereby not only facilitating the user in performing unified and efficient management on the SIM card, but also making full use of the plan of the SIM card, and improving the user experience.

The embodiments of the disclosure also provide a storage medium, in which a computer program is stored. The computer program is configured to perform the method for realizing sharing of an SIM card among multiple terminals in each embodiment.

It should be understood that the apparatus for realizing sharing of an SIM card among multiple terminals and the method for realizing sharing of an SIM card among multiple terminals provided in the above embodiments belong to the same conception. The specific implementation process of the system may refer to the embodiment of the method, and the technical features in the embodiment of the method are applied correspondingly to the embodiment of the apparatus, so they will not be repeated here.

Through the above description of implementations, those skilled in the art may clearly know that the method according to the above embodiment may be implemented by means of software plus a necessary common hardware platform, certainly by means of hardware; but in many cases, the former is the better implementation. Based on this understanding, the technical solutions of the disclosure substantially or the part making a contribution to the prior art may be embodied in the form of software product. The computer software product is stored in a storage medium (e.g. ROM/RAM, a magnetic disk, and a compact disc) and includes a number of instructions to make a terminal device (which may be a mobile phone, a computer, a server, a conditioner, or a network device, etc.) perform the method in each embodiment of the disclosure.

The above is only the preferred embodiments of the disclosure elaborated with reference to the accompanying drawings, not limiting the claims scope of the disclosure. Those skilled in the art may make a variety of variant solutions to implement the disclosure without departing from the scope and essence of the disclosure. For example, characteristics as an embodiment may be applied to another embodiment to obtain yet another embodiment. Any modifications, equivalent replacements and improvements made by using the technical conception of the disclosure shall fall within the claims scope of the disclosure.

### INDUSTRIAL APPLICABILITY

By sharing the number of the SIM card of the primary device with the secondary device, the secondary device may download the information about the number and write the information into the reprogrammable SIM card of the secondary device, so that the secondary device may also use the number to perform the communication services, such as the PS service and the CS service; in such a manner, multiple terminals sharing the data traffic plan or/and the call plan of an SIM card is realized.

1. (canceled)

2. (canceled)

3. A method for realizing sharing of a Subscriber Identity Module (SIM) card among multiple terminals, which is applied to a primary device, comprising:
applying to a cloud server for taking a number of the SIM card of the primary device as a shared number to share with a secondary device;
sending identity information about the secondary device to the cloud server;
wherein the shared number is written into an SIM card of the secondary device, so that the secondary device uses the shared number to perform a communication service when re-accessing a network by means of the SIM card of the secondary device.

4. The method for realizing sharing of the SIM card among multiple terminals according to claim 3, further comprising at least one of the following:
querying the cloud server for usage information about the shared number on the secondary device, or
managing a sharing state of the shared number on the secondary device, through the cloud server.

5. The method for realizing sharing of the SIM card among multiple terminals according to claim 4, wherein managing the sharing state of the shared number on the secondary device comprises:
pausing, resuming or cancelling the sharing of the shared number on the secondary device.

6. A method for realizing sharing of a Subscriber Identity Module (SIM) card among multiple terminals, which is applied to a secondary device, comprising:
downloading information about a shared number from a cloud server, wherein the shared number is a number of the SIM card of a primary device;
writing the information about the shared number into an SIM card of the secondary device;
re-accessing a network through the SIM card of the secondary device; and
performing a communication service by using the shared number.

7. An apparatus for realizing sharing of a Subscriber Identity Module (SIM) card among multiple terminals, which is applied to a primary device, comprising:
a processor; and
a memory, storing instructions, which, when executed by the processor, cause the processor to performing one or more actions, comprising:
applying to a cloud server for taking a number of the SIM card of the primary device as a shared number to share with a secondary device, and sending identity information about the secondary device to the cloud server;
wherein the shared number is written into an SIM card of the secondary device, so that the secondary device uses the shared number to perform a communication service when re-accessing a network by means of the SIM card of the secondary device.

8. The apparatus for realizing sharing of the SIM card among multiple terminals according to claim 7, wherein the one or more actions further comprise:
performing at least one of the following: querying the cloud server for usage information about the shared number on the secondary device, or managing a sharing state of the shared number on the secondary device through the cloud server.

9. The apparatus for realizing sharing of the SIM card among multiple terminals according to claim 8, wherein the managing the sharing state of the shared number on the secondary device through the cloud server comprises: pausing, resuming or cancelling the sharing of the shared number on the secondary device.

10. (canceled)

11. (canceled)

12. The method for realizing sharing of the SIM card among multiple terminals according to claim 6, further comprising:
receiving a detach request from a base station, wherein the detach request is of a type “re-attach required”;
using the shared number to initiate an attach request to the base station, in order to attempt to reactivate the communication service;
receiving an attach reject message from the base station;
using a number of the secondary device to initiate the attach request to the base station.

13. The method for realizing sharing of the SIM card among multiple terminals according to claim 6, further comprising:
receiving a requirement deleting the information about the shared number from cloud server;
initiating an IMSI detach request to a base station;
deleting the information about the shared number; and
using a number of the secondary device to initiate the attach request to the base station.
